(19) United States
(12) Patent Application Publication
(10) Pub. No.: US 2026/0269506 A1
(43) Pub. Date: Sep. 10, 2026

(54) CONNECTOR AND CONNECTOR ASSEMBLY

(71) Applicant: Xuancheng Luxshare Precision Industry Co.,Ltd, Xuancheng City (CN)

(72) Inventors: Ankang SHENG, Xuancheng City (CN); Weihe HONG, Xuancheng City (CN); Haomai YIN, Xuancheng City (CN)

(73) Assignee: Xuancheng Luxshare Precision Industry Co.,Ltd, Xuancheng City (CN)

(21) Appl. No.: 19/371,179

(22) Filed: Oct. 28, 2025

(30) Foreign Application Priority Data
Mar. 10, 2025 (CN) 202510275871.2

(51) Int. Cl. H01R 13/426; H01R 13/436; H01R 13/52

(52) U.S. Cl. CPC H01R 13/426; H01R 13/4361; H01R 13/521; H01R 13/5219; H01R 2201/04

(57) ABSTRACT

Disclosed are a connector and a connector assembly that belong to the field of connector technology. The connector includes an insulating body, a plurality of first terminals, a first locking member, a first sealing ring, and a second sealing ring. The first terminals are inserted on the insulating body. The first locking member is inserted on the insulating body and has relief grooves with the same number of the first terminals. The first locking member is able to be located at a pre-mounting position and a final locking position. The relief grooves on the first locking member at the pre-mounting position are opposite to the first terminals to allow the first terminals to move in first mounting holes. The relief grooves on the first locking member at the final locking position are staggered from the first terminals to lock the first terminals.

### CROSS-REFERENCE TO RELATED APPLICATION

The present application claims priority to Chinese Patent Application No. 2025102758712, filed with the China National Intellectual Property Administration (CNIPA) on Mar. 10, 2025, the disclosure of which is incorporated herein by reference in its entirety.

### TECHNICAL FIELD

This invention relates to the field of connector technology and, in particular, to a connector and a connector assembly.

### BACKGROUND

A connector assembly is a device that connects two active components and is used for transmitting currents or signals. The connector assembly includes a connector and a mating connector that mate with each other. With an increasing demand for communication between electronic devices, the need for the connection and wiring between electronic devices is also growing. To reduce the space cost of connector assemblies used for the connection between electronic devices and improve connection efficiency, a connector is provided with an increasingly large number of terminals.

### SUMMARY

The present invention adopts the technical solutions below.

A connector is provided. The connector includes an insulating body, a plurality of first terminals, a first locking member, a first sealing ring, and a second sealing ring. The insulating body is provided with a plurality of first mounting holes extending in the same direction. Each first mounting hole of the plurality of first mounting holes has a first hole opening and a second hole opening that are opposite to each other. A first terminal of the plurality of first terminals is detachably inserted into a first mounting hole of the plurality of first mounting holes through a respective first hole opening and is connected to a first cable passing through the first mounting hole from the respective first hole opening. The first locking member is detachably inserted into the insulating body. Relief grooves with the same number as the plurality of first terminals are disposed on the first locking member. The first locking member is able to be located at a pre-mounting position and a final locking position. The relief grooves on the first locking member at the pre-mounting position are opposite to the plurality of first terminals. The relief grooves on the first locking member at the final locking position are staggered from the plurality of first terminals. The first sealing ring is secured to a side of the insulating body facing the first hole opening and abuts against the insulating body. The first sealing ring is provided with a plurality of through holes in one-to-one correspondence with a plurality of first cables. The plurality of first cables pass through the plurality of through holes respectively and abut against the first sealing ring. The second sealing ring is sleeved outside the insulating body and abuts against a mating connector sleeved outside the insulating body.

A connector assembly is provided. The connector assembly includes the preceding connector and the mating connector mating with the connector.

### BRIEF DESCRIPTION OF DRAWINGS

FIG. 1 is a structure view of a connector taken from one angle according to an embodiment of this invention.

FIG. 2 is a structure view of a connector taken from another angle according to an embodiment of this invention.

FIG. 3 is an exploded structure view of a connector according to an embodiment of this invention.

FIG. 4 is a side view of a connector according to an embodiment of this invention.

FIG. 5 is a section view taken along A-A of FIG. 4.

FIG. 6 is a section view taken along B-B of FIG. 4 when a second locking member is at the pre-mounting position.

FIG. 7 is a section view taken along B-B of FIG. 4 when a second locking member is at the final locking position.

FIG. 8 is a section view taken along C-C of FIG. 4.

FIG. 9 is a rear view of a connector without a housing.

FIG. 10 is a section view taken along D-D of FIG. 9 when a first locking member is at the pre-mounting position.

FIG. 11 is a section view taken along D-D of FIG. 9 when a first locking member is at the final locking position.

FIG. 12 is a structure view of an insulating body taken from one angle according to an embodiment of this invention.

FIG. 13 is a view of an insulating body taken from another angle according to an embodiment of this invention.

FIG. 14 is a structure view of a second locking member according to an embodiment of this invention.

FIG. 15 is a structure view of a second terminal according to an embodiment of this invention.

FIG. 16 is a structure view of a first locking member according to an embodiment of this invention.

FIG. 17 is a structure view of a first terminal according to an embodiment of this invention.

FIG. 18 is a rear view of a connector with a housing according to an embodiment of this invention.

FIG. 19 is a section view taken along E-E of FIG. 18 when a third locking member is at the pre-mounting position.

FIG. 20 is a section view taken along E-E of FIG. 18 when a third locking member is at the final locking position.

FIG. 21 is a structure view of a third locking member according to an embodiment of this invention.

FIG. 22 is a structure view of a housing taken from one angle according to an embodiment of this invention.

FIG. 23 is a structure view of a housing taken from another angle according to an embodiment of this invention.

FIG. 24 is a structure view of a first sealing ring according to an embodiment of this invention.

FIG. 25 is a structure view of a second sealing ring according to an embodiment of this invention.

### DETAILED DESCRIPTION

This invention is further described in detail hereinafter in conjunction with drawings and embodiments. It is to be understood that the embodiments described herein are intended to explain this invention and not to limit this invention. Additionally, it is to be noted that for ease of description, part, not all, of the structures related to this invention are illustrated in the drawings.

In the description of this invention, terms "joined", "connected", and "secured" are to be understood in a broad sense unless otherwise expressly specified and limited. For example, the term "connected" may refer to "securely connected", "detachably connected", or "integrated", may refer to "mechanically connected" or "electrically connected", may refer to "connected directly" or "connected indirectly through an intermediary", or may refer to "connected inside two elements" or "an interaction relation between two elements". For those of ordinary skill in the art, specific meanings of the preceding terms in this invention may be understood based on specific situations.

In this invention, unless otherwise expressly specified and limited, when a first feature is described as "above" or "below" a second feature, the first feature and the second feature may be in direct contact, or the first feature and the second feature may be in contact via another feature between the two features instead of being in direct contact. Moreover, when the first feature is described as being "on", "above", or "over" the second feature, the first feature is right on, above, or over the second feature, the first feature is obliquely on, above, or over the second feature, or the first feature is simply at a higher level than the second feature. When the first feature is described as being "under", "below", or "underneath" the second feature, the first feature is right under, below, or underneath the second feature, the first feature is obliquely under, below, or underneath the second feature, or the first feature is simply at a lower level than the second feature.

In the description of this embodiment, the orientation or position relationships indicated by terms "above", "below", "left", "right" and the like are based on the orientation or position relationships shown in the drawings. These orientations or position relationships are merely for ease of description and simplifying an operation and do not indicate or imply that the referred device or element must have a specific orientation and must be constructed and operated in a specific orientation. Thus, these orientations or position relationships are not to be construed as limiting this invention. Additionally, terms "first" and "second" are used for distinguishing between descriptions and have no special meanings.

Embodiments of this invention provide a connector and a connector assembly. The connector assembly includes the connector and a mating connector mating with the connector. The connector is connected to a device through a cable, and the mating connector is disposed on a device body of another device. The device where the mating connector is located may be, but is not limited to, a vehicle-mounted processing device such as a domain controller or Interchangeable Virtual Instrumentation (IVI); and the connector may be, but is not limited to, a vehicle-mounted device connected to the vehicle-mounted processing device, such as laser radar or a gateway.

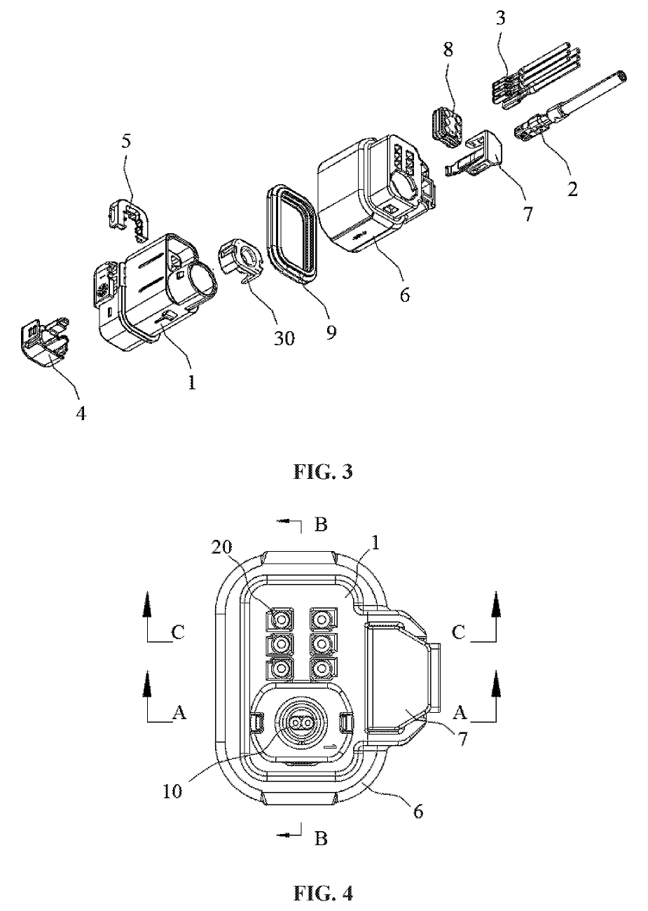

Referring to FIG. 3, the connector includes an insulating body 1, a plurality of first terminals 3, a first sealing ring 8, a second sealing ring 9, and a first locking member 5. The insulating body 1 is provided with a plurality of first mounting holes 12 extending in the same direction. Each first mounting hole 12 has a first hole opening 121 and a second hole opening 122 that are opposite to each other. Each of the first terminals 3 is detachably inserted into a respective first mounting hole 12 through a respective first hole opening 121 so that a first mating terminal that is on a mating connector and is adapted to the first terminal 3 can be electrically connected to the first terminal 3 through a respective second hole opening 122. The first terminal 3 is connected to a respective first cable 20 passing through the insulating body 1 from the first hole opening 121. The first sealing ring is secured to a side of the insulating body 1 facing the first hole opening 121 and abutting against the insulating body 1. The first sealing ring 8 is provided with a plurality of through holes 84 in one-to-one correspondence with a plurality of first cables 20. The first cables 20 are inserted through the through holes 84 and abut against inner walls of the through holes 84 respectively. The second sealing ring 9 is sleeved outside the insulating body 1. A housing of the mating connector can be sleeved on the insulating body 1 and abut against the second sealing ring 9. The first locking member 5 is detachably inserted into the insulating body 1. Relief grooves 513 with the same number as the first terminals 3 are disposed on the first locking member 5. The first locking member 5 is able to be located at a pre-mounting position and a final locking position. The relief grooves 513 on the first locking member 5 at the pre-mounting position are opposite to the first terminals 3 to allow the first terminals 3 to be inserted into or pulled out of the first mounting holes 12. The relief grooves 513 on the first locking member 5 at the final locking position are staggered from the first terminals 3 to lock the first terminals 3 simultaneously.

The preceding connector and the connector assembly use the first locking member 5 to lock the first terminals 3 simultaneously, simplifying the structure of the connector and the structure of the connector assembly and thereby reducing the assembly difficulty of the connector and the connector assembly. Moreover, the first locking member 5 able to be located at the pre-mounting position and the final locking position can be assembled on the insulating body 1 before the first terminals 3 are inserted into the insulating body 1, thereby preventing the first locking member 5 from being lost. Besides, the first sealing ring 8 is used for sealing the first cables 20 and the insulating body 1, and the second sealing ring 9 is used for sealing the connector and the mating connector, thereby improving the sealing performance of the entire connector assembly and resulting in good dustproof and waterproof effects. Additionally, the first sealing ring 8 can seal the first terminals 3 and the insulating body 1 simultaneously, thereby further simplifying the assembly difficulty of the connector and the connector assembly.

Referring to FIG. 12, the side of the insulating body 1 facing the first hole opening 121 is formed with a mounting groove 110 communicating with the first mounting holes 12. The first sealing ring 8 is embedded into the mounting groove 110 and abuts against the groove wall of the mounting groove 110. The arrangement of the mounting groove 110 improves the stability of the connection between the first sealing ring 8 and the insulating body 1.

Referring to FIG. 24, to improve the sealing performance of the first sealing ring 8, the first sealing ring 8 includes a sealing body 83 and multiple first annular protrusions 81 spaced apart on the outer wall surface of the sealing body 83 in the length direction of a first mounting hole 12 to increase the contact area with the groove sidewall of the mounting groove 110 and improve the sealing performance. Moreover, multiple second annular protrusions 82 are spaced apart on the hole wall of a through hole 84 in the length direction of the through hole 84 to increase the contact area with a first cable 10 and improve the sealing performance. In this embodiment, the length direction of the through hole 84 is consistent with the length direction of the first mounting hole 12 to reduce the bending deformation of the first cable 10.

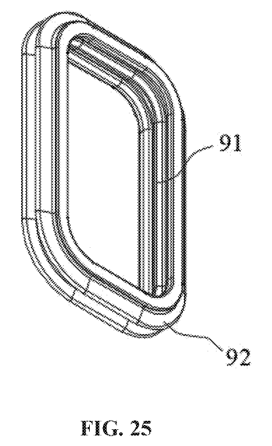

Referring to FIG. 25, multiple third annular protrusions 91 and multiple fourth annular protrusions 92 are formed on the inner circumferential wall of the second sealing ring 9 and the outer circumferential wall of the second sealing ring 9 respectively. The third annular protrusions 91 are spaced apart in the length direction of the first mounting hole 12. The fourth annular protrusions 92 are spaced apart in the length direction of the first mounting hole 12. Such an arrangement increases the contact area between the second sealing ring 9 and the insulating body 1 and the contact area between the connector and the mating connector, thereby improving the sealing performance.

Referring to FIGS. 1 to 3, the connector further includes a second terminal 2 and a second locking member 4. The insulating body 1 is further provided with a second mounting hole 11. The second terminal 2 is detachably inserted into the second mounting hole 11. A second fastener 13 is disposed within the second mounting hole 11. First fasteners 14 are disposed within the first mounting holes 12 respectively. The second fastener 13 is arranged to lock the second terminal 2 at a preset position of the second mounting hole 11. The first fasteners 14 are arranged to lock the first terminals 3 at preset positions of the first mounting holes 12 respectively. The second locking member 4 is also detachably inserted into the insulating body 1 and is able to be located at a pre-mounting position and a final locking position. The second locking member 4 at the pre-mounting position allows the second terminal 2 to be inserted into the second mounting hole 11. The second locking member 4 at the final locking position enables the second fastener 13 to keep locking the second terminal 2.

In the preceding connector, the second fastener 13 is used for locking the second terminal 2 once, and then the second locking member 4 is used for limiting the position of the second fastener 13 so that the second fastener 13 can keep locking the second terminal 2, thereby improving the stability of the connection between the second terminal 2 and the insulating body 1. Moreover, the first fasteners 14 lock the first terminals 3 once, and the first locking member 5 locks the first terminals 3 twice, improving the stability of the connection between the first terminals 3 and the insulating body 1 and thereby improving the assembly stability of the entire connector.

In this embodiment, the second terminal 2 is connected to a second cable 10 and has a different function from a first terminal 3. For example, if the second terminal 2 is a signal terminal for transmitting an Ethernet signal, the second cable 10 connected to the second terminal 2 is a high-speed signal cable; if the first terminal 3 is a low-voltage terminal for transmitting, for example, a low-speed controller area network (CAN) signal, a respective first cable 20 connected to the first terminal 3 is a low-voltage cable. To be adapted to the second terminal 2 and the first terminal 3, the second mounting hole 11 and a respective first mounting hole 12 have different internal spaces, and the internal space of the second mounting hole 11 is larger than the internal space of the first mounting hole 12.

It is to be understood that to enable the sealing between the second terminal 2 and the insulating body 1, a sealing member abutting against the insulating body 1 may also be securely sleeved on the second terminal 2, which is not described in detail herein.

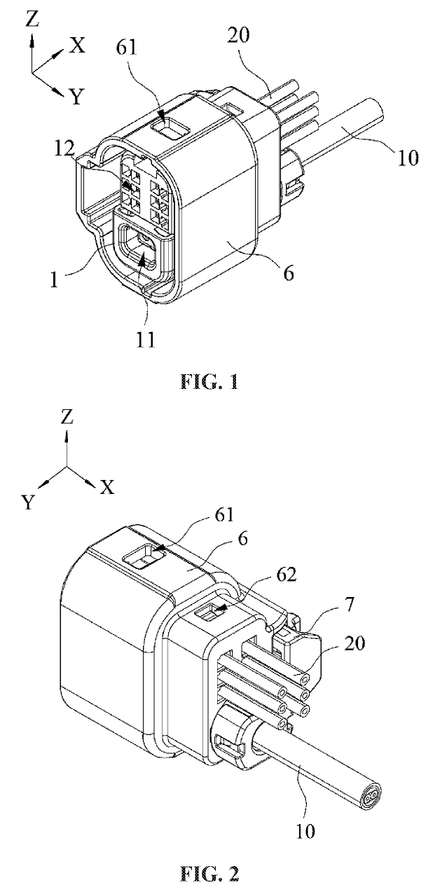

Referring to FIGS. 1 and 2, the second mounting hole 11 and the first mounting hole 12 both extend in the first direction (direction X and the reverse direction of direction X in FIG. 1, where direction X is the forward direction of the first direction, and the reverse direction of direction X is the reverse direction of the first direction), and the second mounting hole 11 and the first mounting hole 12 are spaced apart in a third direction (direction Z and the reverse direction of direction Z in FIG. 1, where direction Z is the forward direction of the third direction, and the reverse direction of direction Z is the reverse direction of the third direction) perpendicular to the first direction. Based on the limitation on the size of the internal space of the second mounting hole 11 and the limitation on the size of the internal space of the first mounting hole 12, to reduce the difficulty of assembling the second locking member 4 and the first locking member 5 on the insulating body 1, the second locking member 4 is switched between the pre-mounting position and the final locking position by moving in the first direction, and the first locking member 5 is switched between the pre-mounting position and the final locking position by moving in the third direction.

Exemplarily, one second mounting hole 11 is provided, and six first mounting holes 12 are provided. The six first mounting holes 12 are arranged in two symmetrical rows in a second direction (direction Y and the reverse direction of direction Y in FIG. 1, where direction Y is the forward direction of the second direction, and the reverse direction of direction Y is the reverse direction of the second direction). Any row of first mounting holes 12 include three first mounting holes 12 spaced apart in the third direction. The number of first terminals 3 is the same as the number of first mounting holes 12. Six first terminals 3 are also provided. In this case, the first locking member 5 moving in the third direction can lock the multiple first terminals 3 simultaneously. The second direction is perpendicular to the first direction and the third direction.

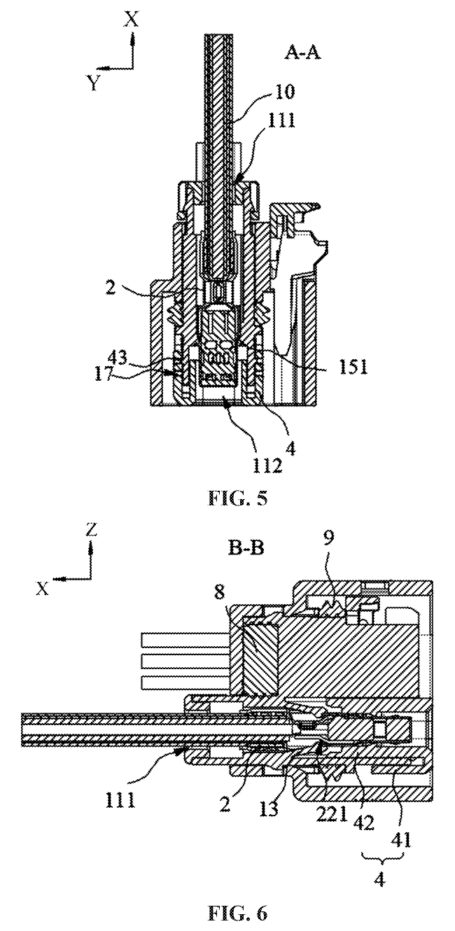

Referring to FIGS. 5 to 7, the second mounting hole 11 is provided with a third hole opening 111 and a fourth hole opening 112 that are opposite to each other in the first direction. The third hole opening 111 is provided on a forward side of the fourth hole opening 112 in the first direction. The second terminal 2 can be inserted into the second mounting hole 11 from the third hole opening 111 and moved toward the fourth hole opening 112. A second mating terminal adapted to the second terminal 2 and located on the mating connector can be electrically connected to the second terminal 2 through the fourth hole opening 112. A first stop surface 151 is formed on a side of the inner wall of the second mounting hole 11 facing the fourth hole opening 112. The first stop surface 151 can abut against a first abutting surface 211 on the second terminal 2, thereby preventing the second terminal 2 from continuing moving toward the fourth hole opening 112, so that the second terminal 2 can be inserted into the preset position of the second mounting hole 11.

Specifically, referring to FIGS. 5 and 12, the inner wall surface of the second mounting hole 11 is provided with two first stop blocks 15 opposite to each other in the second direction. The first stop surface 151 is formed on the inner side surface of the first stop block 15 and is arranged to gradually move away from the hole wall of the second mounting hole 11 from an end facing the third hole opening 111 to an end facing away from the third hole opening 111. Correspondingly, the first abutting surface 211 is also inclined.

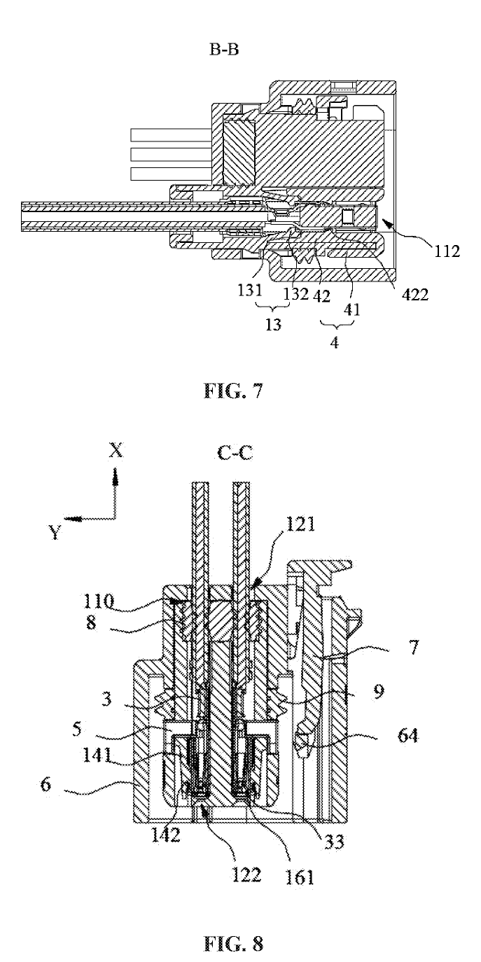

Referring to FIGS. 6 and 7, the outer wall surface of the second terminal 2 is provided with a first recess 221, and the second fastener 13 includes a first elastic arm 131 and a first locking block 132 that are integrally molded. One end of the first elastic arm 131 facing the third hole opening 111 is connected to the hole wall of the second mounting hole 11, and the other end of the first elastic arm 131 gradually moves away from the hole wall of the second mounting hole 11 in the direction toward the fourth hole opening 112. The first locking block 132 is disposed on a side of the first elastic arm 131 facing away from the hole wall of the second mounting hole 11. The first locking block 132 is snap-fit into the first recess 221.

The second terminal 2 can press the second fastener 13 after being inserted into the second mounting hole 11 from the third hole opening 111. The first elastic arm 131 deforms to drive the first locking block 132 to move toward the hole wall of the second mounting hole 11 until the first locking block 132 is locked into the first recess 221. At this time, the first stop surface 151 abuts against the first abutting surface 211, and the second fastener 13 locks the second terminal 2 to prevent the second terminal 2 from moving toward the third hole opening 111.

Specifically, two second fasteners 13 are symmetrically disposed within the second mounting hole 11 in the third direction to improve the locking stability of the second fasteners 13 on the second terminal 2. More specifically, the two second fasteners 13 are disposed within two gaps formed by the two first stop blocks 15 respectively and connected to the first stop blocks 15 to improve the structural strength of the second fasteners 13.

More specifically, a side of the first locking block 132 facing the third hole opening 111 is provided with a first guide surface. The first guide surface gradually moves away from the hole wall of the second mounting hole 11 from a side facing the third hole opening 111 to a side facing away from the third hole opening 111 to reduce the difficulty of crossing the first locking block 132 when an end of the second terminal 2 inserted into the second mounting hole 11 moves toward the fourth hole opening 112.

In this embodiment, to reduce the difficulty of inserting the second terminal 2 into the second mounting hole 11, the area of the third hole opening 111 is larger than the maximum cross-sectional area of the second terminal 2. On this basis, the connector further includes an end cover 30. The end cover 30 is mounted on the insulating body 1 and located on a side of the third hole opening 111 of the second mounting hole 11. The end cover 30 is provided with a threading for a first cable 20 to pass. The area of the threading hole is smaller than the area of the third hole opening 111.

After the second terminal 2 connected to the second cable 10 is inserted into the second mounting hole 11, the end cover 30 is mounted on the insulating body 1, reducing the possibility of shaking the second cable 10 and improving the stability of the entire connector. Specifically, the end cover 30 is snap-fit into the insulating body 1 to facilitate the maintenance and replacement of the second terminal 2.

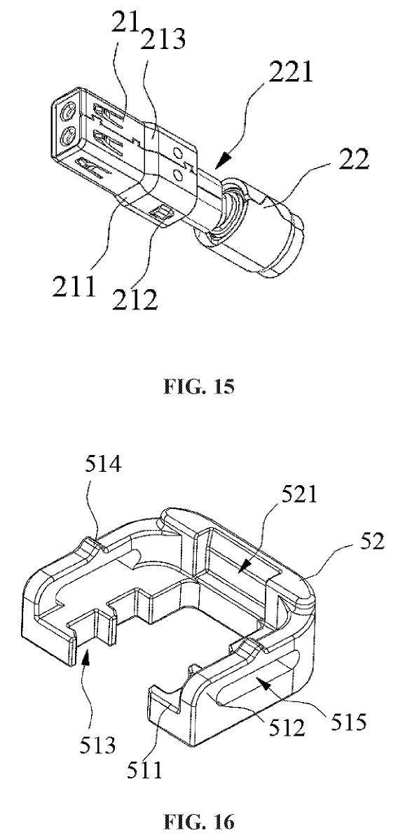

Referring to FIG. 15, the second terminal 2 includes a front shielding shell 21, an inner conductor, a wire clamp, and a rear shielding shell 22. A rear end of the front shielding shell 21 is sleeved on the rear shielding shell 22 and crimped with the rear shielding shell 22. The inner conductor is located within the front shielding shell 21 and is configured to be electrically connected to the second mating terminal and the second cable 10. The wire clamp is located within the rear shielding shell 22 and is configured to secure one end of the second cable 10 within the rear shielding shell 22. The front shielding shell 21 is provided with a small-diameter section and a large-diameter section in sequence in the reverse direction of the first direction. The first abutting surface 211 is formed between the large-diameter section and the small-diameter section. The rear shielding shell 22 is in the shape of a dumbbell. The first recess 221 is an annular groove formed on the rear shielding shell 22. The annular groove is located outside the front shielding shell 21.

It is to be understood that in other embodiments, the first recess 221 may be disposed on the first elastic arm 131, and the first locking block 132 is disposed on the second terminal 2.

Referring to FIGS. 12 and 15, to prevent the second terminal 2 from being inserted into the second mounting hole 11 too far and causing damage to the second terminal 2 or the insulating body 1, in this embodiment, the inner side surface of a first stop block 15 is also formed with a guide groove 152 extending in the first direction. A side of the guide groove 152 facing the fourth hole opening 112 is closed. The outer wall surface of the second terminal 2 is provided with a guide block 212 that is in a slidable fit into the guide groove 152. When the second terminal 2 is at the preset position within the second mounting hole 11, the guide block 212 abuts against the groove wall at an end of the guide groove 152 facing the fourth hole opening 112. Specifically, the guide block 212 is disposed on the outer wall surface of the large-diameter section.

Referring to FIG. 14, the second locking member 4 includes a sleeve portion 41 and an insertion portion 42. The sleeve portion 41 is connected to the insertion portion 42 and located outside the insertion portion 42. A clamping space having an opening facing the third hole opening 111 is formed between the sleeve portion 41 and the insertion portion 42. The insertion portion 42 is inserted into the second mounting hole 11 from the fourth hole opening 112. The sleeve portion 41 is sleeved outside the insulating body 1. In this manner, the sidewall of the insulating body 1 is clamped within the clamping space.

The second locking member 4 is inserted into the second mounting hole 11 from the fourth hole opening 112. Referring to FIGS. 6 and 7, when the second locking member 4 is at the pre-mounting position, the second locking member 4 and the second fasteners 13 are spaced apart in the first direction, and the second locking member 4 does not interfere with the deformation of the second fasteners 13 so that the second terminal 2 can be inserted into the preset position of the second mounting hole 11 from the third hole opening 111; when the second locking member 4 is at the final locking position, the second fasteners 13 move toward the second terminal 2 in the first direction, the inner side of the insertion portion 42 abuts against sides of the second fasteners 13 facing away from the second terminal 2, and limited by the insertion portion 42, the second fasteners 13 are no longer capable of deforming toward the hole wall of the second mounting hole 11 and thereby keeps snap-fit into the second terminal 2, thereby maintaining the stability of the second terminal 2 inserted into the second mounting hole 11. It is to be noted that when the second locking member 4 is at the final locking position, the end surface of the insulating body 1 abuts against a side of the clamping space facing away from the opening, preventing the second locking member 4 from continuing moving toward the third hole opening 111.

Specifically, a step surface 421 is formed at the end of the insertion portion 42 inserted into the second mounting hole 11. When the second locking member 4 is at the final locking position, a second fastener 13 abuts against the step surface 421 to determine the final locking position of the second locking member 4, better reducing the possibility that the second locking member 4 is excessively inserted into the second mounting hole 11.

Moreover, a second stop surface 422 is formed on a side of the second locking member 4 facing the second terminal 2. The second stop surface 422 gradually moves away from the hole wall of the second mounting hole 11 from an end facing the third hole opening 111 to an end facing away from the third hole opening 111. The second abutting surface 213 that is in a fit into the second stop surface 422 is formed on the outer wall surface of the second terminal 2. When the second locking member 4 is at the final locking position, the second stop surface 422 abuts against the second abutting surface 213 and cooperates with the first stop surface 151 and the first abutting surface 211 to better prevent the second terminal 2 from moving toward the fourth hole opening 112.

More specifically, two opposite second stop surfaces 422 are formed on the inner sidewall of the second locking member 4. Correspondingly, two second abutting surfaces 213 are also formed. The two second abutting surfaces 213 are also formed between the small-diameter section of the front shielding shell 21 and the large-diameter section of the front shielding shell 21. That is, the second abutting surface 213 and the first abutting surface 211 jointly form a conical surface connecting the large-diameter section and the small-diameter section.

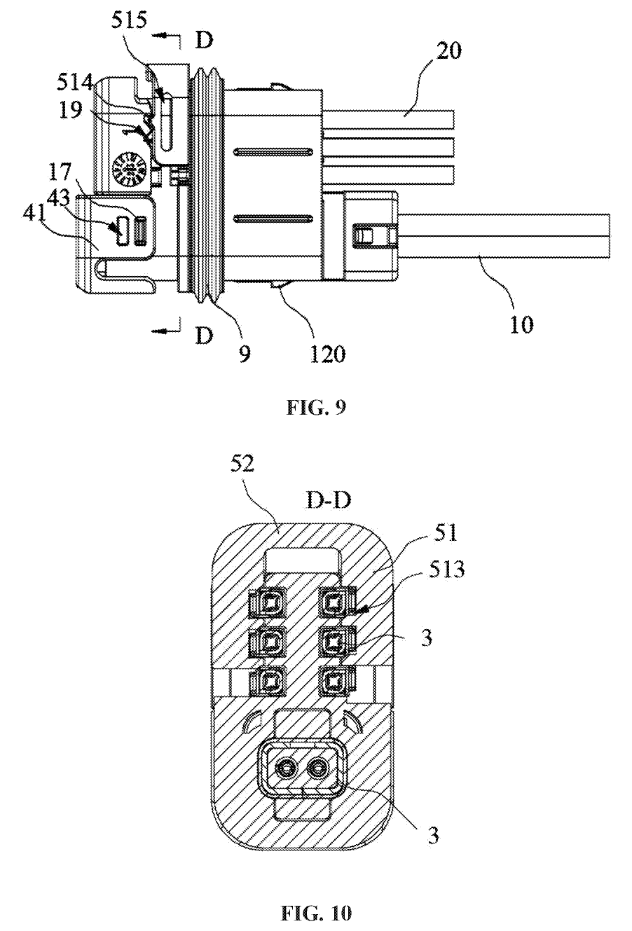

Referring to FIGS. 5 and 9, to facilitate the observation of whether the second locking member 4 is at the pre-mounting position or the final locking position and improve the stability of assembling the second locking member 4 on the insulating body 1, a first positioning block 17 is also disposed on one of the second locking member 4 or the insulating body 1, and a first slot hole 43 that is snap-fit into the first positioning block 17 is formed on the other one of the second locking member 4 or the insulating body 1. Two first slot holes 43 are provided and spaced apart in the first direction. When the first positioning block 17 is limited in one of the two first slot holes 43 far from the fourth hole opening 112, the second locking member 4 is at the pre-mounting position. When the first positioning block 17 is limited in one of the two first slot holes 43 adjacent to the fourth hole opening 112, the second locking member 4 is at the final locking position.

Exemplarily, the first positioning block 17 is disposed on the insulating body 1, and the first slot holes 43 are formed on the second locking member 4. Specifically, the cross section of the first positioning block 17 is arranged as an equilateral trapezoid or an equilateral triangle with chamfered corners to reduce the difficulty of the first positioning block 17 entering and leaving the first slot holes 43.

Referring to FIG. 14, to reduce the difficulty of separating the second locking member 4 from the insulating body 1, an avoidance notch 411 is formed on the sleeve portion 41, and the avoidance notch 411 extends in the first direction to the end surface of the sleeve portion 41 facing the second terminal 2. When the second locking member 4 is disassembled by applying a force to the sleeve portion 41 in the direction away from the insulating body 1 in the second direction, the first positioning block 17 can be separated from the first slot holes 43.

Referring to FIG. 8, a first mounting hole 12 has a first hole opening 121 and a second hole opening 122 that are opposite to each other in the first direction. The first hole opening 121 and the third hole opening 111 are located on the same side of the insulating body 1. A third stop surface 161 is formed on a side of the first mounting hole 12 facing the second hole opening 122. The third stop surface 161 can abut against a third abutting surface 33 on a first terminal 3, preventing the first terminal 3 from continuing moving toward the second hole opening 122 so that the first terminal 3 can be inserted into the preset position of the first mounting hole 12.

Specifically, an annular second stop block 16 is disposed on the side of the first mounting hole 12 facing the second hole opening 122, the third stop surface 161 is formed on a side of the second stop block 16 facing away from the second hole opening 122 and is arranged as a conical surface, the third stop surface 161 gradually expands from an end facing the second hole opening 122 to an end facing away from the second hole opening 122, the conical third abutting surface 33 is formed on the outer wall surface of the first terminal 3, and when the third abutting surface 33 abuts against the third stop surface 161, the first terminal 3 is inserted into the preset position of the first mounting hole 12.

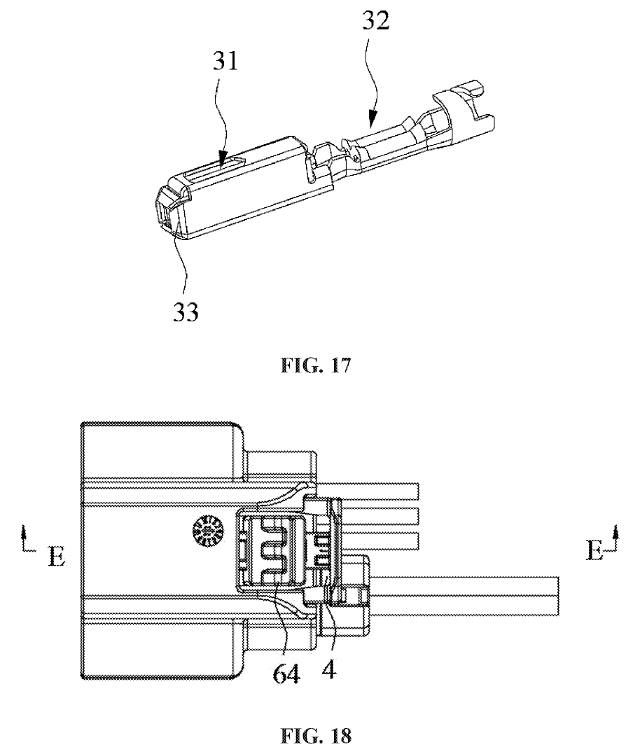

Referring to FIGS. 8 and 17, the outer wall surface of the first terminal 3 is provided with a second recess 31, and a first fastener 14 includes a second elastic arm 141 and a second locking block 142 that are integrally molded. One end of the second elastic arm 141 facing the first hole opening 121 is connected to the hole wall of the first mounting hole 12, and the other end of the second elastic arm 141 gradually moves away from the hole wall of the first mounting hole 12 in the direction toward the second hole opening 122. The second locking block 142 is disposed on the side of the second elastic arm 141 facing away from the hole wall of the first mounting hole 12 and is snap-fit into the second recess 31. Specifically, the second recess 31 is a groove formed on the outer wall surface of the first terminal 3.

The first terminal 3 can press the first fastener 14 after being inserted into the first mounting hole 12 from the first hole opening 121. The second elastic arm 141 deforms to drive the second locking block 142 to move toward the hole wall of the first mounting hole 12 until the second locking block 142 is locked into the second recess 31. At this time, the third stop surface 161 abuts against the third abutting surface 33, and the first terminal 3 is locked under the cooperation of the first fastener 14.

In this embodiment, a side of the second locking block 142 facing the first hole opening 121 is also provided with a second guide surface. The second guide surface is gradually inclined from a side facing the first hole opening 121 to the central direction of the first mounting hole 12 to reduce the difficulty of crossing the second locking block 142 when an end of the first terminal 3 inserted into the first mounting hole 12 moves toward the second hole opening 122.

It is to be understood that the position of the second recess 31 and the position of the second locking block 142 may be interchanged between the second elastic arm 141 and the first terminal 3.

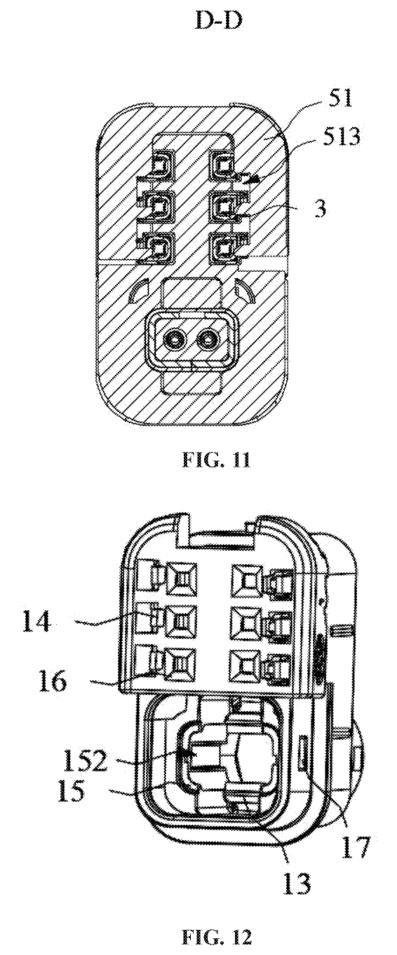

The first locking member 5 is inserted, in the reverse direction of the third direction, into the insulating body 1 from a side facing away from the second terminal 2. Referring to FIGS. 10, 11, and 16, the relief grooves 513 penetrate the first locking member 5 in the first direction and are spaced apart in the third direction.

In order to avoid the first locking member 5 when the first locking member 5 moves in the third direction, an avoidance groove 32 is disposed on a respective terminal 3. Multiple avoidance grooves 32 located on the first terminals 3 are arranged in the third direction.

In an example in which the first terminals 3 are disposed in two symmetrical rows and spaced apart in the second direction, with continued reference to FIG. 16, the first locking member 5 includes a connecting portion 52 and two cantilever portions 51. The two cantilever portions 51 are disposed on two opposite sides of the connecting portion 52 in the second direction respectively and are perpendicular to the connecting portion 52 so that the first locking member 5 can be approximately U-shaped. The relief grooves 513 are formed on the cantilever portions 51. When the cantilever portions 51 are inserted into the insulating body 1 until the first terminals 3 are at the pre-mounting position, the relief grooves 513 on the cantilever portions 51 are in one-to-one correspondence with the first terminals 3, not affecting the insertion of the first terminals 3 into the first mounting holes 12 or the separation of the first terminals 3 from the first mounting holes 12. As the cantilever portions 51 continue being inserted into the insulating body 1 until the first terminals 3 are at the final locking position, the relief grooves 513 avoid the first terminals 3, preventing the first terminals 3 from moving toward the second hole openings 122.

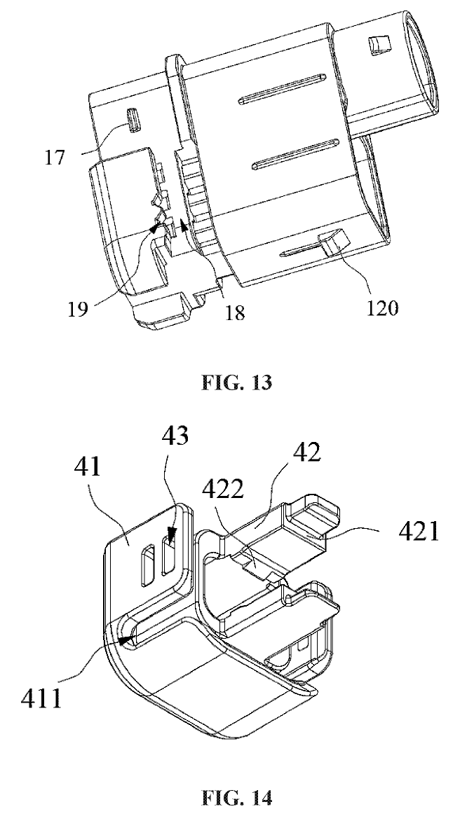

Referring to FIG. 13, to guide the first terminals 3 when the first terminals 3 are inserted into the insulating body 1, the outer wall of the insulating body 1 is provided with two fixing grooves 18 extending in the third direction. Each of the two fixing grooves 18 communicates with a respective row of the two rows of first mounting holes 12. Each of the two cantilever portions 51 is inserted into the insulating body 1 along a respective one of the two fixing grooves 18.

Further, to facilitate the observation of whether the first locking member 5 is at the pre-mounting position or the final locking position and improve the stability of assembling the first locking member 5 on the insulating body 1, a second positioning block 514 is also disposed on one of the first locking member 5 or the insulating body 1, and a second slot hole 19 that is snap-fit into the second positioning block 514 is formed on the other one of the first locking member 5 or the insulating body 1. Two second slot holes 19 are provided and spaced apart in the direction in which the first locking member 5 is inserted into the insulating body 1. When the second positioning block 514 is limited in one of the two second slot holes 19 far from the second terminal 2, the first locking member 5 is at the pre-mounting position. When the second positioning block 514 is limited in one of the two second slot holes 19 adjacent to the second terminal 2, the first locking member 5 is at the final locking position.

Exemplarily, the second positioning block 514 is disposed on a cantilever portion 51 of the first locking member 5. A second positioning block 514 is disposed on each of the two cantilever portions 51. The second slot holes 19 corresponding to the second positioning blocks 514 are formed on slot sidewalls of the two fixing grooves 18 respectively.

To reduce the difficulty of the second positioning block 514 entering the second slot hole 19, the second positioning block 514 is designed to be triangular. Moreover, the first locking member 5 is also provided with a strip-shaped avoidance hole 515 extending in the third direction. When the second positioning block 514 enters the second slot hole 19, the avoidance hole 515 provides an avoidance space for the deformation of the first locking member 5. Specifically, the cantilever portion 51 further includes a mounting portion 512 and a locking portion 511 that are L-shaped. The mounting portion 512 and the locking portion 511 are both connected to the connecting portion 52. The mounting portion 512 can slide in a fixing groove 18, and the locking portion 511 is inserted into the first mounting hole 12. The second positioning block 514 and the relief grooves 513 are provided on the mounting portion 512 and the locking portion 511 respectively, and the avoidance hole 515 is also provided on the mounting portion 512. It is to be understood that the arrangement of the avoidance hole 515 reduces the material cost of manufacturing the first locking member 5.

More specifically, to reduce the difficulty of disassembling the first locking member 5, a force applying groove 521 for convenient force application is also formed on the connecting portion 52.

Referring to FIGS. 3 and 8, the connector further includes the first sealing ring 8. The first sealing ring 8 is disposed at second hole openings 122 of the first mounting holes 12 and is provided with the through holes 84 for second cables 10 to pass through. The first sealing ring 8 can seal gaps between the second hole openings 122 and the first terminals 3, achieving dustproof and waterproof effects.

Referring to FIGS. 1 to 3, the connector further includes a housing 6 that is securely sleeved outside the insulating body 1 to protect the insulating body 1. A gap exists between the housing 6 and the insulating body 1 for the mating connector to be inserted into. Specifically, the housing 6 has an inner cavity that has an opening on the opposite side in the first direction, and the insulating body 1 is located within the inner cavity of the housing 6. An operation hole 61 communicating with the inner cavity of the housing 6 is formed at a position of the housing 6 corresponding to the connecting portion 52 of the first locking member 5. A force in the direction of the second terminal 2 can be applied to the first locking member 5 through the operation hole 61 so that the first locking member 5 can be switched from the pre-mounting position to the final locking position.

It is to be noted that the length of the operation hole 61 in the second direction is smaller than the length of the connecting portion 52 in the second direction, that is, the orthographic projection area of the first locking member 5 in the direction facing the operation hole 61 is greater than the area of the operation hole 61, thereby preventing the first locking member 5 from being separated from the insulating body 1 from the operation hole 61 during transportation or from being squeezed to the final locking position during transportation.

Specifically, referring to FIGS. 9, 22, and 23, the housing 6 is provided with a third slot hole 62, and the insulating body 1 is provided with a third positioning block 120 that is snap-fit into the third slot hole 62. The third positioning block 120 is limited within the third slot hole 62, thereby achieving a detachable and securing connection between the insulating body 1 and the housing 6. More specifically, two third slot holes 62 are symmetrically provided on the housing 6 in the third direction, and two third positioning blocks 120 are provided to improve the stability of the connection between the housing 6 and the insulating body 1. Moreover, an inclined third guide surface is formed at an end of the third positioning block 120 facing away from a slot opening of the housing 6 to reduce the difficulty of clamping the third positioning block 120 into the third slot hole 62. Certainly, the third slot hole 62 may also be provided on the insulating body 1, and the third positioning block 120 may also be disposed on the housing 6.

Referring to FIG. 16, the third hole opening 111 and the first hole opening 121 on the insulating body 1 both face a closed end of the housing 6, and the closed end of the housing 6 is provided with multiple exit holes 63 formed at positions corresponding to the second mounting hole 11 and the first mounting holes 12 and configured for the first cables 10 and the second cables 10 to pass through respectively. The mating connector can be electrically connected to the connector from an opened end of the housing 6.

A gap exists between the housing 6 and an end of the insulating body 1 facing the opening of the housing 6 and is configured for the mating connector to be inserted into. To lock the mating connector to the connector, the housing 6 further includes a third fastener 64 disposed on the inner wall of the housing 6. The third fastener 64 is snap-fit into the connector.

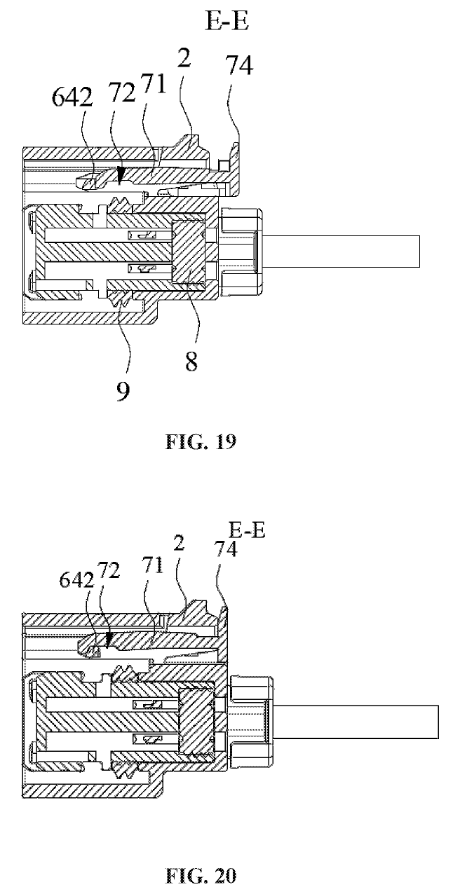

Specifically, referring to FIGS. 19 and 22, the third fastener 64 includes a third elastic arm 641 and a third recess 643. The third elastic arm 641 is connected to the inner wall of the housing 6. The third recess 643 is formed at an end of the third elastic arm 641 extending toward the slot opening. A third locking block that is in a fit into the third recess 643 is formed on the mating connector. The third locking block can be locked into the third recess 643 to lock the mating connector.

More specifically, two third elastic arms 641 are provided and spaced apart in the third direction. The two third elastic arms 641 are connected by a connecting rod 642 so that the preceding third recess 643 is formed between the two third elastic arms 641, and the third locking block is locked into the third recess 643 and abuts against the connecting rod 642.

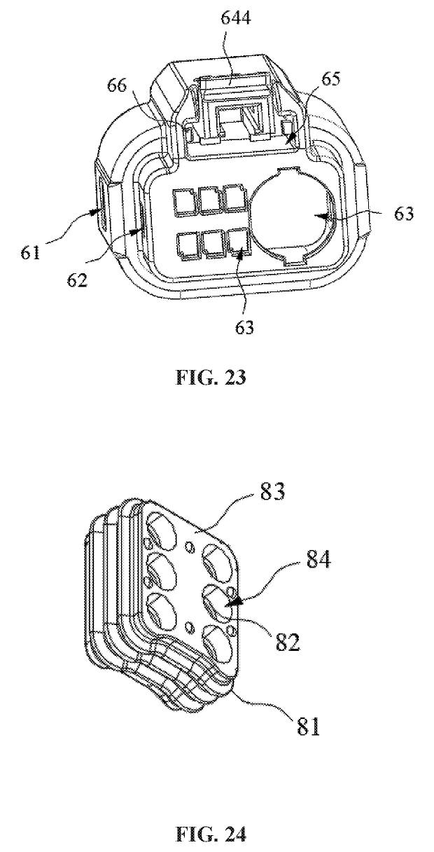

Referring to FIGS. 19 and 23, an insertion hole 65 is formed at the closed end of the housing 6 for the third fastener 64 to extend into the inner cavity of the housing 6. The insertion hole 65 communicates with the inner cavity of the housing 6. The third elastic arm 641 is connected to the hole wall of the insertion hole 65 through a fulcrum. One end of the third elastic arm 641 connected to the connecting rod 642 extends from the insertion hole 65 into the inner cavity of the housing 6, and the other end of the third elastic arm 641 is located outside the housing 6. To unlock the third fastener 64 from the mating connector, it is only necessary to press the end of the third elastic arm 641 located outside the housing 6.

To better improve the stability between the connector and the mating connector, the connector further includes a third locking member 7. The third locking member 7 also has a pre-mounting position and a final locking position. The third locking member 7 at the pre-mounting position allows the mating connector to be inserted into the preset position within the housing 6. The third locking member 7 at the final locking position makes the third fastener 64 keep locking the mating connector.

With continued reference to FIGS. 19 and 20, the third locking member 7 is inserted into the housing 6 from the closed end of the housing 6 in the first direction, and the third locking member 7 includes a locking arm 71. An end portion of the locking arm 71 of the third locking member 7 at the pre-mounting position is located on a side of the connecting rod 642 facing away from the opening of the housing 6. The locking arm 71 on the third locking member 7 at the final locking position abuts against the outer side of the third fastener 64, preventing the third fastener 64 from moving toward a side facing away from the third locking block. Specifically, the locking arm 71 is formed with a locking groove 72. The connecting rod 642 can be locked into the locking groove 72 and abut against the groove bottom of the locking groove 72.

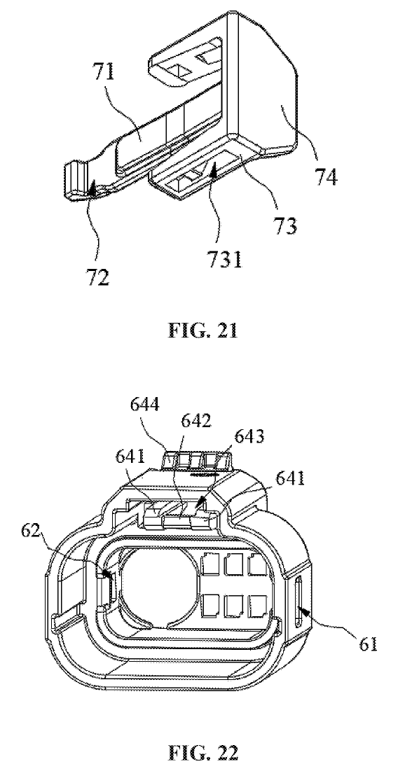

Referring to FIGS. 21 and 23, to improve the stability of assembling the third locking member 7 on the housing 6, a fourth positioning block 66 is also disposed on one of the third locking member 7 or the housing 6, and a fourth slot hole 731 that is snap-fit into the fourth positioning block 66 is formed on the other one of the third locking member 7 or the housing 6. Two fourth slot holes 731 are provided and spaced apart in the first direction. When the fourth positioning block 66 is locked in one of the two fourth slot holes 731 far from the opened end of the housing 6, the third locking member 7 is at the pre-mounting position. When the fourth positioning block 66 is locked in one of the two fourth slot holes 731 adjacent to the opened end of the housing 6, the third locking member 7 is at the final locking position.

Exemplarily, the third slot hole 62 is formed on the third locking member 7, and the third positioning block 120 is disposed on the housing 6, specifically on the hole wall of the insertion hole 65. Specifically, the third locking member 7 includes two positioning arms 73 disposed on two opposite sides of the locking arm 71 and spaced apart in the third direction. The two positioning arms 73 are both connected to the locking arm 71 and inserted into the insertion hole 65. The third slot hole 62 is formed on a positioning arm 73. Moreover, to reduce the difficulty of disassembling and assembling the third locking member 7, the third locking member 7 further includes a sliding plate 74. The sliding plate 74 is connected to the locking arm 71 and an end portion of the positioning arm 73 located outside the housing 6.

With continued reference to FIG. 23, to facilitate the application of a force to the third fastener 64 to separate the mating connector from the connector, for each third elastic arm 641, an end of the third elastic arm 641 facing away from the connecting rod 642, that is, the end of the third elastic arm 641 located outside the housing 6, is connected to a U-shaped connecting block 644, and the third elastic arm 641 is connected to two ends of the connecting block 644. The force applied to the connecting block 644 may make the third elastic arm 641 move away from the third locking block under the action of a lever so that the third elastic arm 641 is separated from the third locking block. The locking arm 71 of the third locking member 7 extends through the connecting block 644 and is inserted into the housing 6. The unlocking of the third locking member 7 and the unlocking of the third fastener 64 do not interfere with each other.

When the preceding connector is assembled, the injection-molded first locking member 5 is inserted into the insulating body 1 in the third direction so that the first locking member 5 is at the pre-mounting position; the second sealing ring 9 is sleeved on the insulating body 1; the injection-molded second locking member 4 is inserted into the second mounting hole 11 in the first direction so that the second locking member 4 is at the pre-mounting position; the first sealing ring 8 is mounted within the mounting groove 110; the housing 6 is sleeved on the insulating body 1; the third locking member 7 is inserted into the housing 6; the second terminal 2 and the first terminal 3 are inserted; the second locking member 4 and the first locking member 5 are pushed to the final locking positions when required.

When the second terminal 2 is required to be removed from the second mounting hole 11 so that a new second terminal 2 can be mounted, the second locking member 4 is removed from the insulating body 1 through a tool and then inserted into the second mounting hole 11 through the tool, and then the second fastener 13 is pried toward the hole wall of the second mounting hole 11 through the tool so that the second terminal 2 is separated from the insulating body 1, thereby effectively reducing fault maintenance costs. When the first terminal 3 is required to be removed from the first mounting hole 12 so that a new first terminal 3 can be mounted, a force facing away from the insulating body 1 in the third direction may be applied to the first locking member 5 through the force applying groove 521 so that the first locking member 5 is removed from the insulating body 1; and then a force facing away from the first terminal 3 is applied to the first fastener 14 through the tool entering the first mounting hole 12 so that the first fastener 14 is separated from the first terminal 3, and so that the first terminal 3 is separated from the insulating body 1. When the mating connector and the connector are required to be separated, a pressure is applied to the sliding plate 74 of the third locking member 7 so that an end of the third locking member 7 that is snap-fit into the third fastener 64 is separated from the third fastener 64, and then the third locking member 7 is withdrawn out of the housing 6; then a pressure is applied to the connecting block 644 of the third fastener 64 so that an end of the third fastener 64 that is snap-fit into the mating connector is separated from the mating connector so that the mating connector is withdrawn out of the housing 6.

Apparently, the preceding embodiments of this invention are only illustrative examples of this invention and are not intended to limit embodiments of this invention. Those of ordinary skill in the art can make various apparent modifications, adaptations, and substitutions without departing from the scope of this invention. All embodiments do not need to be and cannot be exhausted herein. Any modifications, equivalent substitutions, and improvements made within the spirit and principle of this invention fall within the scope of the claims of this invention.

What is claimed is:

1. A connector, comprising:
an insulating body provided with a plurality of first mounting holes extending in a same direction, wherein each first mounting hole of the plurality of first mounting holes has a first hole opening and a second hole opening that are opposite to each other;
a plurality of first terminals, wherein a first terminal of the plurality of first terminals is detachably inserted into a first mounting hole of the plurality of first mounting holes through a respective first hole opening and is connected to a first cable passing through the first mounting hole from the respective first hole opening;
a first locking member detachably inserted into the insulating body, wherein relief grooves with a same number as the plurality of first terminals are disposed on the first locking member, the first locking member is able to be located at a pre-mounting position and a final locking position, the relief grooves on the first locking member at the pre-mounting position are opposite to the plurality of first terminals, and the relief grooves on the first locking member at the final locking position are staggered from the plurality of first terminals;
a first sealing ring secured to a side of the insulating body facing the first hole opening and abutting against the insulating body, wherein the first sealing ring is provided with a plurality of through holes in one-to-one correspondence with a plurality of first cables, and the plurality of first cables pass through the plurality of through holes respectively and abut against the first sealing ring; and
a second sealing ring sleeved outside the insulating body and abutting against a mating connector sleeved outside the insulating body.

2. The connector according to claim 1, wherein the plurality of first mounting holes extend in a first direction and are arranged in two symmetrical rows in a second direction; any row of first mounting holes comprise multiple first mounting holes spaced apart in a third direction; and the first direction, the second direction, and the third direction are perpendicular to each other.

3. The connector according to claim 2, wherein the first locking member comprises a connecting portion and two cantilever portions, the connecting portion is connected to the two cantilever portions, the relief grooves are formed on the cantilever portions, and the two cantilever portions are inserted into the insulating body and are arranged to lock first terminals in two rows of first mounting holes respectively.

4. The connector according to claim 1, wherein a second positioning block is disposed on one of the first locking member or the insulating body, a second groove hole snap-fit into the second positioning block is disposed on other of the first locking member or the insulating body, and two second groove holes are spaced apart in a direction in which the first locking member is inserted into the insulating body.

5. The connector according to claim 1, wherein the first locking member comprises a cantilever portion, the second positioning block and the relief grooves are all disposed on the cantilever portion, and an avoidance hole is also disposed on the cantilever portion and extends in the direction in which the first locking member is inserted into the insulating body.

6. The connector according to claim 1, further comprising a housing securely sleeved outside the insulating body, wherein a gap for the mating connector to get inserted into is formed between the housing and the insulating body, and the housing is further provided with an exit hole for the plurality of first cables to pass through.

7. The connector according to claim 6, wherein an operation hole is disposed on a side of the housing corresponding to the first locking member, and an orthographic projection area of the first locking member in a direction facing the operation hole is greater than an area of the operation hole.

8. The connector according to claim 6, further comprising a third locking member, wherein the third locking member is inserted into the housing and is arranged to lock the mating connector.

9. The connector according to claim 8, further comprising a second terminal, wherein the insulating body is provided with a second mounting hole, and the second terminal is inserted into the second mounting hole, wherein the first terminal is a low-voltage terminal, and the second terminal is a terminal for transmitting an Ethernet signal.

10. The connector according to claim 2, further comprising a housing securely sleeved outside the insulating body, wherein a gap for the mating connector to get inserted into is formed between the housing and the insulating body, and the housing is further provided with an exit hole for the plurality of first cables to pass through.

11. The connector according to claim 3, further comprising a housing securely sleeved outside the insulating body, wherein a gap for the mating connector to get inserted into is formed between the housing and the insulating body, and the housing is further provided with an exit hole for the plurality of first cables to pass through.

12. The connector according to claim 4, further comprising a housing securely sleeved outside the insulating body, wherein a gap for the mating connector to get inserted into is formed between the housing and the insulating body, and the housing is further provided with an exit hole for the plurality of first cables to pass through.

13. The connector according to claim 5, further comprising a housing securely sleeved outside the insulating body, wherein a gap for the mating connector to get inserted into is formed between the housing and the insulating body, and the housing is further provided with an exit hole for the plurality of first cables to pass through.

14. A connector assembly, comprising a connector and a mating connector mating with the connector,
wherein the connector comprises:
an insulating body provided with a plurality of first mounting holes extending in a same direction, wherein each first mounting hole of the plurality of first mounting holes has a first hole opening and a second hole opening that are opposite to each other;
a plurality of first terminals, wherein a first terminal of the plurality of first terminals is detachably inserted into a first mounting hole of the plurality of first mounting holes through a respective first hole opening and is connected to a first cable passing through the first mounting hole from the respective first hole opening;
a first locking member detachably inserted into the insulating body, wherein relief grooves with a same number as the plurality of first terminals are disposed on the first locking member, the first locking member is able to be located at a pre-mounting position and a final locking position, the relief grooves on the first locking member at the pre-mounting position are opposite to the plurality of first terminals, and the relief grooves on the first locking member at the final locking position are staggered from the plurality of first terminals;
a first sealing ring secured to a side of the insulating body facing the first hole opening and abutting against the insulating body, wherein the first sealing ring is provided with a plurality of through holes in one-to-one correspondence with a plurality of first cables, and the plurality of first cables pass through the plurality of through holes respectively and abut against the first sealing ring; and
a second sealing ring sleeved outside the insulating body and abutting against the mating connector sleeved outside the insulating body.

15. The connector assembly according to claim 14, wherein the plurality of first mounting holes extend in a first direction and are arranged in two symmetrical rows in a second direction; any row of first mounting holes comprise multiple first mounting holes spaced apart in a third direction; and the first direction, the second direction, and the third direction are perpendicular to each other.

16. The connector assembly according to claim 15, wherein the first locking member comprises a connecting portion and two cantilever portions, the connecting portion is connected to the two cantilever portions, the relief grooves are formed on the cantilever portions, and the two cantilever portions are inserted into the insulating body and are arranged to lock first terminals in two rows of first mounting holes respectively.

17. The connector assembly according to claim 14, wherein a second positioning block is disposed on one of the first locking member or the insulating body, a second groove hole snap-fit into the second positioning block is disposed on other of the first locking member or the insulating body, and two second groove holes are spaced apart in a direction in which the first locking member is inserted into the insulating body.

18. The connector assembly according to claim 14, wherein the first locking member comprises a cantilever portion, the second positioning block and the relief grooves are all disposed on the cantilever portion, and an avoidance hole is also disposed on the cantilever portion and extends in the direction in which the first locking member is inserted into the insulating body.

19. The connector assembly according to claim 14, further comprising a housing securely sleeved outside the insulating body, wherein a gap for the mating connector to get inserted into is formed between the housing and the insulating body, and the housing is further provided with an exit hole for the plurality of first cables to pass through.

20. The connector assembly according to claim 19, wherein an operation hole is disposed on a side of the housing corresponding to the first locking member, and an orthographic projection area of the first locking member in a direction facing the operation hole is greater than an area of the operation hole.
